(19) United States
(12) Patent Application Publication
(10) Pub. No.: US 2009/0151217 A1
(43) Pub. Date: Jun. 18, 2009

(54) Animated duck decoy

(76) Inventor: Michael Gregory, Anderson, SC (US)

Correspondence Address: LEIGH P. GREGORY, PO BOX 168, CLEMSON, SC, 29633-0168, US

(21) Appl. No.: 12/291,978

(22) Filed: Nov. 14, 2008

Related U.S. Application Data
(60) Provisional application No. 61/003,057, filed on Nov. 14, 2007.

(51) Int. Cl. A01M 31/06

(52) U.S. Cl. 43/3

(57) ABSTRACT

A waterfowl decoy includes an air blower contained within a rigid, floatable, waterproof housing. At least one air line extends from the blower out of the portion of the housing which extends below the water line during flotation in order to produce movement of the underlying water and, thereby, movement of the decoy device.

The present application claims the benefit of prior provisional U.S. Ser. No. 61/003,057, filed Nov. 14, 2007.

### FIELD OF THE INVENTION

The present invention is directed to an animated waterfowl decoy for attracting ducks or other waterfowl to a particular body of water or location in a body of water.

### BACKGROUND OF THE INVENTION

Traditionally, hunters have used unanimated devices that resemble waterfowl with varying degrees of realism. These traditional designs did nothing more than float passively in the water or stand statically on a pole-mounted assembly. More recently, there have been attempts to give decoys some type and degree of motion in order to better simulate live waterfowl. Examples of such are decoys which include motorized paddles for propelling the floating decoy through the water and means for effecting wing, tail or head movement to give the decoy a more realistic appearance.

Overall, prior efforts to create a realistic form of motion in a waterfowl decoy have fallen short of producing lifelike motion and a realistic appearance. Further, many of the prior art designs have been complex, expensive to produce, and/or difficult to use. For example, swimming decoys propelled by a motor-driven propeller can easily get “stuck” if the propeller gets stopped with a weed or stick and, accordingly, these devices don't work well in very shallow water.

U.S. Pat. No. 6,655,070 to Wood is directed to a moving, floating waterfowl decoy propelled by a steam jet motor. The steam jet propulsion system is powered by combustion of fuel and is suggested to provide lifelike natural movements, wakes, ripples and splashes.

U.S. Pat. No. 5,566,491 to Phillips is directed to manual system for forcing air through a plastic air line from the hunter to one or more floating decoys such that the air is released underneath the floating decoy. The bubbles create rings and waves around the decoy and simulate movement.

U.S. Pat. No. 6,088,944 to Jones is directed to an apparatus for oscillating a floating decoy in order to simulate the appearance of a feeding water-fowl. A rigid extension member having a buoyancy container at its end is attached to a floating decoy. Air is periodically pumped into the container by means of an air pump contained within the decoy housing, thereby uprighting the decoy. As the air escapes from the container it fills with water thereby tipping the decoy into a feeding position.

While some of these prior art efforts have come a long way toward providing decoys having reasonably life-like motions, they do so in a complicated manner which, as was noted above, is expensive to produce, and, most often, difficult for the hunter to use.

### SUMMARY OF THE INVENTION

Accordingly, the present invention is directed to a waterfowl decoy device, which includes a rigid, floatable, water-proof housing having a waterfowl-shaped portion for extending above the water line during flotation and a base portion for extending below the water line during flotation, an air blower, which includes a pump and a power source, the blower contained within the housing, and at least one air line extending from the air blower and out of the base portion of the housing, such that when the housing is floating air produced by the blower passes through the air line and out of the base portion below the water line producing movement of the underlying water and thereby producing movement of the decoy device. In a preferred embodiment there are several air lines extending from the air blower and out of the base portion of the housing.

Preferably, the air blower includes a diaphragm-type air pump, although other types of air pumps are also within the scope of the present invention. Most typically, the power source for the blower is a battery, optionally a rechargeable battery.

### BRIEF DESCRIPTION OF THE FIGURES OF THE DRAWING

FIG. 1 is a schematic top view of a waterfowl decoy in accordance with the present invention;

FIG. 2 is a schematic side view of a waterfowl decoy in accordance with the present invention;

FIG. 3 is a schematic front view of a waterfowl decoy in accordance with the present invention; and

FIG. 4 is a schematic side of an alternate embodiment of the waterfowl decoy of the present invention.

### DETAILED DESCRIPTION OF THE PREFERRED EMBODIMENTS

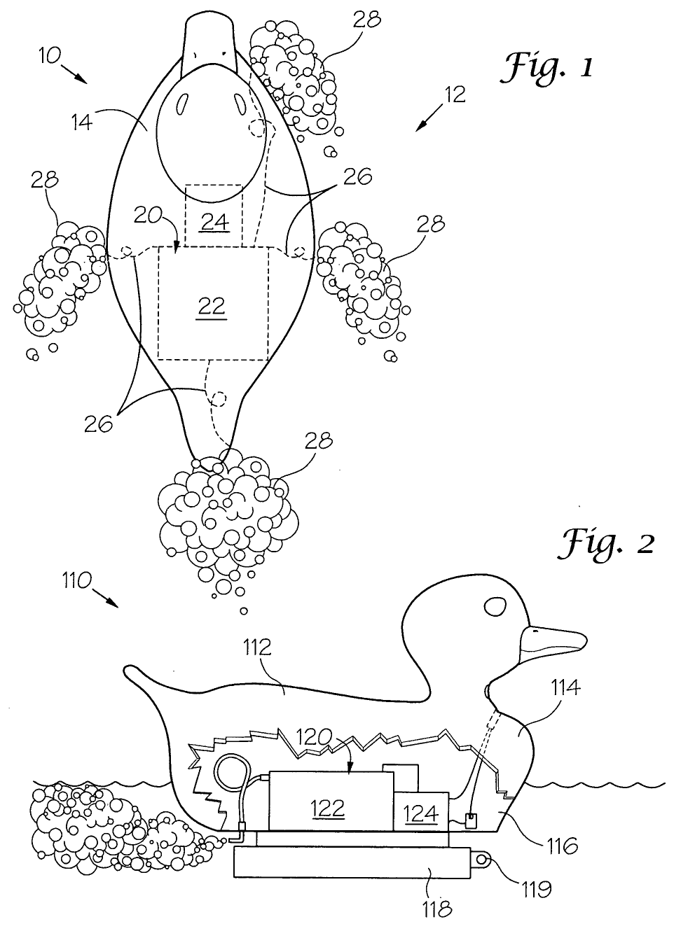

FIG. 1 is a top view of the present inventive waterfowl decoy device 10, which includes a rigid, floatable, waterproof housing 12 having a waterfowl-shaped portion 14 for extending above the water line during flotation. A base portion, which extends below the water line during flotation, is not shown in this view. An air blower 20, which includes a pump 22 and a power source 24, is shown schematically. The blower 20 is contained within the housing 12, and, in this embodiment, includes a plurality of air lines 26 extending from the air blower and out of the base portion of the housing, such that when the housing is floating air produced by the blower passes through the air lines and out of the base portion below the water line producing movement of the surrounding and underlying water (represented schematically at 28) and thereby producing movement of the decoy device.

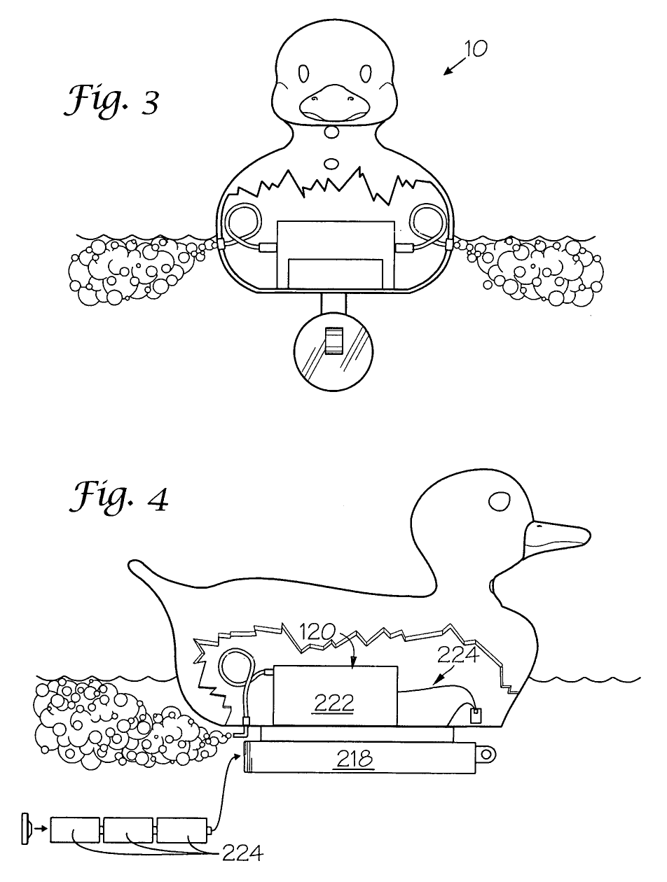

FIG. 3 is a front view of the waterfowl decoy device 10 of FIG. 1.

FIG. 2 is a side view of a waterfowl decoy device 110 in accordance with the present invention including rigid, floatable, waterproof housing 112 having a waterfowl-shaped portion 114 for extending above the water line during flotation. Base portion 116, which extends below the water line during flotation is shown in this view and includes keel 118. Air blower 120, including pump 122 and power source 124, is shown schematically. The blower 120 is contained within the housing 112, and, in this embodiment, includes a single air line 126 extending from the air blower and out of the base portion of the housing, such that when the housing is floating air produced by the blower passes through the air line and out of the base portion 116 below the water line producing movement of the surrounding and underlying water (represented schematically at 128) and thereby producing movement of the decoy device. Also shown in FIG. 2 are air intake port 130 and eyelet 119 defined in the keel for attaching an optional towline.

FIG. 4 is a side view of an alternative embodiment in which the power source 224, in this case a plurality of batteries are stored in the keel 218. Access cap 230 is threadably removable and provides a watertight seal during use.

Preferably, the air pump employed in accordance with the present invention is a diaphragm-type air pump, although other types of air pumps such as centrifugal pumps and piston pumps are also within the scope of the present invention. Most typically, the power source is a battery, optionally a rechargeable battery. In a preferred embodiment the pump is a small battery-operated air pump, such as a bait-bucket aerator pump or a small aquarium pump and the power source is one or more “D”-cell batteries. An on/off switch may be employed directly or as a remote activation source. A valve may be positioned in air lines 22 to prevent water leaking back towards the pump. Alternatively, air lines 22 may extend above the water line to act as an inverted “u” trap having a submerged portion and an unsubmerged portion, so that water cannot leak through the submerged portion to the unsubmerged portion. Any small battery operated air pump can be used in the present invention and any decoy can be modified for use. Air lines 22 can be formed of various plastics or metals. Several of the components can be integrated for ease of manufacturing.

The foregoing description has been limited to specific embodiments of this invention. It will be apparent, however, that variations and modifications may be made by those skilled in the art to the disclosed embodiments of the invention, with the attainment of some or all of its advantages and without departing from the spirit and scope of the present invention. For example, although the air pump and power source are preferably housed internally, they can be mounted under the decoy housing.

It will be understood that various changes in the details, materials, and arrangements of the parts which have been described and illustrated above in order to explain the nature of this invention may be made by those skilled in the art without departing from the principle and scope of the invention as recited in the following claims.

What is claimed is:

1. A waterfowl decoy device, comprising:
a rigid, floatable, water-proof housing comprising a waterfowl-shaped portion for extending above the water line during flotation and a base portion for extending below the water line during flotation;
an air blower comprising a pump and a power source, the blower contained within the housing; and
at least one air line extending from the air blower and out of the base portion of the housing;
such that when the housing is floating air produced by the blower passes through the air line and out of the base portion below the water line producing movement of the underlying water and thereby producing movement of the decoy device.

2. The water fowl decoy device set forth in claim 1 comprising a plurality of air lines extending from the air blower and out of the base portion of the housing.

3. The water fowl decoy device set forth in claim 1 wherein the air blower comprises a diaphragm-type air pump.

4. The water fowl decoy device set forth in claim 1 wherein the power source comprises a battery.

5. The water fowl decoy device set forth in claim 4 wherein the battery is rechargeable.
